(19) United States
(12) Patent Application Publication
(10) Pub. No.: US 2025/0327249 A1
(43) Pub. Date: Oct. 23, 2025

(54) A PRINTABLE OR PRINTED PAPER FOR DECORATIVE ELEMENTS, DECORATIVE ELEMENTS COMPRISING A PRINTED PAPER AND A METHOD FOR MANUFACTURING SAID DECORATIVE ELEMENT

(71) Applicant: Unilin, BV, Wielsbeke (BE)

(72) Inventors: Benjamin CLEMENT, Wielsbeke (BE); Michiel BLIEK, Wielsbeke (BE)

(73) Assignee: Unilin, BV, Wielsbeke (BE)

(21) Appl. No.: 18/992,811

(22) PCT Filed: Jul. 4, 2023
(86) PCT No.: PCT/IB2023/056934

§ 371 Date: Jan. 9, 2025

(30) Foreign Application Priority Data
Jul. 5, 2022 (EP) 22183114.2

(51) Int. Cl. D21H 17/00; B41M 5/52; D21H 17/36; D21H 17/37; D21H 17/66; D21H 19/20; D21H 19/58

(52) U.S. Cl. CPC D21H 17/74; B41M 5/5218; B41M 5/5254; B41M 5/5281; D21H 17/36; D21H 17/37; D21H 17/66; D21H 19/20; D21H 19/58

(57) ABSTRACT

A printable paper may be provided for being printed by inkjet printing and forming a decorative paper. The printable paper may include a base paper layer being at least partially impregnated with a polymeric binder. The polymeric binder may be substantially free from formaldehyde. An ink receiver coating may be provided on a surface of the base paper layer. The ink receiver coating may include a binder and a flocculant, which may be a cationic metal salt.

This application claims priority under 35 USC § 119(a)-(d) from EP patent application Ser. No. 22183114.2, which was filed on Jul. 5, 2022, the entire content of which is incorporated herein by reference.

### BACKGROUND

### 1. Field

The present invention relates to a printable and/or printed paper for manufacturing decorative elements, decorative panels comprising a printed paper and a method for manufacturing said decorative elements.

More particularly the invention is related to a printable and/or printed paper of the type being impregnated with a polymeric binder and adapted for being attached, in particular glued, on top of a substrate for forming said decorative elements. Said paper is normally impregnated with the polymeric binder during the manufacturing process of the paper itself, so that the paper is often called pre-impregnated paper (PIP or PRIP).

Said decorative element can be wall, ceiling, furniture elements or profiled elements like skirtings, or edge banding. It is noted that said decorative elements are normally intended to be used in application where there is no need of an overlay layer that provides an extensive wear resistance like in floor application and can have nonplanar shape so that may not be suitable for being manufactured in short cycle press manufacturing processes. The decorative element is normally finished by the application of a lacquer on top of the paper.

### 2. Related Art

Traditionally, the decor or pattern of such decorative element is printed on the paper by means of offset or rotogravure printing. As a consequence of these printing techniques, the printed ink forms a substantially uniform film on the surface of the paper that together with the polymeric binder, of the paper itself, substantially seals the porosity at the decorated surface. The decorative paper forms, therefore, a suitable support for the subsequent lacquering, in such a way that the lacquer can be applied homogeneously with a reduced risk of pores forming that would lead to glossiness loss and to a decrease in term of cleanability.

The printing of paper by means of an analog printing process, such as by rotogravure or offset printing, at affordable prices inevitably leads to large minimal order quantities of a particular decorative paper and restricts the attainable flexibility. A change of decor or pattern necessitates a standstill of the printing equipment of about 6 hours. This standstill time is needed for exchange of the printing rollers, the cleaning of the printing equipment and for adjusting the colors of the new decor or pattern to be printed.

Instead of analog printing techniques digital printing techniques, especially inkjet printing technique, is becoming increasingly popular for the creation of decors or patterns. Such digital techniques can enhance the flexibility in the printing of decors significantly. Reference is made to the EP 1 872 959, WO 2011/124503, EP 1 857 511, EP 2 431 190 and the EP 2 293 946, where such techniques are disclosed.

Because of their higher fluidity, low viscosity and low amount of binder when compared to those used in gravure printing, inks for inkjet printing are deeply absorbed by the paper with consequent bleeding that causes loss of image definition and color tone. Therefore, in order to be able to print with inkjet printing technology it is necessary to provide an ink receiver coating on top of the paper which allows for an immediate absorption of the ink and immobilization of the pigment on the surface. In order to properly absorb the ink, the presently available ink receiver coatings show a porous structure that complicates subsequent lacquering operation. It is also noted that since the paper is pre-impregnated the application of the ink receiver coating, especially, in line with the manufacturing of the paper can be troublesome because of the reduced absorption capacity of the paper.

### SUMMARY

The present invention aims in the first place at an alternative printable paper for decorative elements, and seeks, in accordance with several of its preferred embodiments, to solve one or more of the problems arising in the state of the art.

Therefore, the present invention relates to a printable paper for being printed by inkjet printing, comprising a base paper sheet being at least partially impregnated with a polymeric binder and an ink receiver coating provided on at least a surface of said base paper sheet, said ink receiver coating comprising at least a binder and a flocculant salt. The inventor has found that the combination of flocculant with a binder can provide for an ink receiver coating forming a substantially smooth surface for improving subsequent lacquering of the paper.

It is noted that preferably said polymeric binder impregnating the base paper sheet is substantially free from formaldehyde, for example the formaldehyde content is below 0.2 mg/m2h according to gas analysis method DIN EN ISO 12460-3. For example, the base paper can show an impregnation degree, before applying the ink receiver coating is below 40%, preferably below 30%. In the most preferable embodiment, the polymeric binder can comprise an acrylic resin, a polymer latex like a meth acrylic dispersion, a polyurethane dispersion, preferably water-based polyurethane dispersion, starch dispersion or a combination thereof. Preferred combinations are combination of polyurethane dispersion with acrylic resin or combination of polymer latex with starch dispersion.

Said base paper layer can comprise a base weight, before impregnation, between 50 and 110 g/m2.

Although in the preferred embodiment the base paper sheet is white, in some alternative embodiment can be a colored paper, for example yellow, beige, brown, grey or black. the base color of the paper can be selected in such a way to limit the consumption of ink during printing the décor and can be selected on the basis of the décor to be printed. For example for a wood décor it can be yellow, beige or brown.

The base paper sheet can comprise an ash content up to 34%.

The flocculant can comprise, or preferably consist of, a metal salt, preferably a cationic metal salt. Preferably said metal salt is chosen from the list comprising, preferably consisting of CaCl2, MgCl2, CaBr2, MgBr2, CMA (Calcium Magnesium Acetate), NH4Cl, Calcium Acetate, ZrCl4, calcium nitrate and Magnesium Acetate. The positive ion of the dissolved metal salt will tend to neutralize the electrosteric stabilization function of the pigment contained in the ink thereby improving its absorption. The flocculating agent pulls the ink pigments out of the ink dispersion. Thereby the pigments are prevented from penetration to far down into the ink receiver coating and paper. Mainly the vehicle of the ink, e.g. the water in the case of waterbased inks, is absorbed deeper down into the ink receiver coating. In some alternative embodiments said flocculant can also be chosen from the list consisting of sodiumaluminate, a double sulphate salt such as alum, polyaluminumchloride, polyacrylate, dicyandiamide (e.g. Floquat DI5 from SNF) and polyacrylamide. The most preferred cationic metal salts are CaCl2, MgCl2, Al Cl2, CMA, Calcium Acetate, calcium nitrate and Magnesium Acetate, as the inventors have obtained the best results with these ink reactive compounds especially in term of color intensity and color gamut development.

Preferably, the ink receiver coating is provided with 20 to 80%, based on dry coating weight of flocculating agent, in particular of metal salt.

Preferably, said base paper layer is provided with 0.2 to 7 g/m², and preferably between 0.5 and 5 g/m², dry coating weight of said ink receiver coating. According to the most preferred embodiment, for the binder in said ink receiver coating at least or mainly polyvinyl alcohols are used.

According to variants, the ink receiver coating includes, as a binder, a polymer selected from the group consisting of hydroxyethyl cellulose; hydroxypropyl cellulose; hydroxyethylmethyl cellulose; hydroxypropyl methyl cellulose; hydroxybutylmethyl cellulose; methyl sodium cellulose; carboxymethyl cellulose; sodium carboxymethylhydroxethyl cellulose; water soluble ethylhydroxyethyl cellulose; cellulose sulfate; vinylalcohol copolymers; polyvinyl acetate; polyvinyl acetal; polyvinyl pyrrolidone; polyacrylamide; acrylamide/acrylic acid copolymer; polystyrene, styrene copolymers; acrylic or methacrylic polymers; styrene/acrylic copolymers; ethylene-vinylacetate copolymer; vinyl-methyl ether/maleic acid copolymer; poly (2-acrylamido-2-methyl propane sulfonic acid); poly (diethylene triamine-co-adipic acid); polyvinyl pyridine; polyvinyl imidazole; polyethylene imine epichlorohydrin modified; polyethylene imine ethoxylated; ether bond-containing polymers such as polyethylene oxide (PEO), polypropylene oxide (PPO), polyethylene glycol (PEG) and polyvinyl ether (PVE); polyurethane; melamine resins; gelatin; carrageenan; dextran; gum arabic; casein; pectin; albumin; chitins; chitosans; starch; collagen derivatives; collodion and agar-agar. It is noted that since the polymeric binder in the base paper is preferably melamine resin free, the polymeric binder can also show a poor, or even or none, affinity with melamine resin. To this am the most preferred variants for the binder are polyvinyl acetates, ethylvinylacetates, block copolymers based on polyvinylacetate, block copolymers based on polyvinylalcohol, acrylates, latexes, polyvinyl derivaties, polyurethanes based on polyols and isocyanates, polyurethanes based on polycarbamates and polyaldehydes, e.g. both as a watery dispersion/emulsion or a watery or solvent solution.

As stated above preferred binders for the ink receiving layer include polyvinyl alcohol (PVA), but according to variants a vinyl-alcohol copolymer or modified polyvinyl alcohol may be applied. The modified polyvinyl alcohol may be a cationic type polyvinyl alcohol, such as the cationic polyvinyl alcohol grades from Kuraray, such as POVAL C506, POVAL C118 from Nippon Goshei.

The ink receiver coating can further comprise a crosslinking agent. Preferably, the ink receiver coating can preferably comprise a content of crosslinking agent below 5% based on dry weight of the composition. The crosslinking agent can be preferably selected from the group comprising: aldehydes, polyaldehydes, dialdehydes, alcohols, boronic acid, borax, polyalcohols, carbamates, polycarbamates, carbonic acids, glyoxal based agent, zirconium-based agents, titanates and polycarbonic acids.

According to a first preferred embodiment, the ink receiver coating has water absorbing substances content below 5%, preferably below 1%, more preferably is free from water-absorbing substances. The inventor has found that by reducing the quantity of water absorbing substance, and preferably omitting it, the porosity and surface roughness of the ink receiver coating can be dramatically reduced so that lacquering can be improved. On the other hand, the printing quality can be maintained thanks to the presence of the flocculant. Within the context of the present application with water absorbing particle or substance is meant a substance, in particular in form of particle that is able to absorb liquid in particular the vehicle of the ink. Thus, the invention is not limited to water absorbing particle but is meant to encompass liquid absorbing substances. Said water absorbing substance can comprise pigments, in particular minerals, like silicate or aluminum silicates, for example talc, clays, calcined clays, kaolin, silica.

According to a second preferred embodiment the water absorbing substance comprises particles having a maximum particle size of 7 microns, more preferably of 5 microns. The inventor has found that by using such small particles their effect on the pores forming is reduced so that the ink receiver coating will form a substantially smooth surface.

According to this second preferred embodiment, it may be preferable that said ink receiver coating in in form of a unique layer on the surface of the paper, preferably wherein the composition of the ink receiver coating is substantially uniform on thickness of the paper. In fact, it is noted that some known inkjet receiving layer used in décor paper, for example that described in WO 2017/130117, provides for a dual layer structure of the ink receiver coating wherein said layers have different compositions. This is often necessary to prevent dust release from the ink receiver coating itself. The inventors have found that, in virtue of the presence of the polymeric binder in the paper, a lower amount of binder of the ink receiver coating is absorbed by the paper itself, therefore the binder in the ink receiver coating is almost completely available for bonding the water absorbing particles without the need of an extra layer on top, even in presence of a high particle to binder ratio. In some variants of this second embodiment the particle to binder ratio can be 10/1.

Said base paper layer can be provided with 0.1 to 10 g/m², and preferably between 0.2 and 5 g/m², dry coating weight of said ink receiver coating. According to the most preferred embodiment, for the binder in said ink receiver coating at least or mainly polyvinyl alcohols are used.

The printable paper of the first independent aspect can be manufactured in a dedicated papermill that can preferably comprise a size press for the inline impregnation of the base paper sheet with the polymeric binder. In some embodiments the said paper mill can comprise an inline coating station for the application of the ink receiver coating, though in the preferred embodiment the ink receiver coating can be applied in a separate coating station. The inventors have found that by using a separate coating station, the ink receiver coating is applied when the polymeric binder impregnating the base paper sheet is stabilized so that the ink receiver coating itself stays on top of the surface of the base paper sheet and can form a more uniform coating on the surface of the base paper sheet. In some embodiment said separate coating station can be in line with a printer for printing a décor on the line. The ink receiver coating can be applied via various application techniques like gravure rollers, anilox, spraying, jetting.

The printable paper of the first independent aspect is adapted to be printed in an inkjet printing process that can be either multi-pass or, preferably, a single pass process. The printing operation involves the firing of droplets of ink on said printable paper using inkjet printing heads, preferably piezoelectric printing heads.

During said printing operation it is preferable to use water-based inks, although in alternative embodiments solvent based, oil-based or UV based ink can be used. Water based can be easily and quickly dried so that they are immediately fixed on the ink receiver coating. By immediately drying the ink and preventing an excessive penetration thereof in the ink receiver coating, it is possible to maintain a high intensity of color in the pattern even in case of absence of water-absorbing particles in the ink receiver coating. Preferably said ink are pigment containing inks. Pigments provide for a better UV resistance and higher color intensity than dye containing ink. Said pigment can be either organic or inorganic.

In some embodiments, the dry weight of the total volume of said pigment containing inks deposited for forming said décor is 9 grams per square meter or lower, preferably 3 to 4 grams per square meter or lower.

Said décor or pattern can be formed using multiple colored inks. Said inks can be part of a set comprising multiple color selected from the group consisting of: black, cyan, magenta, yellow, red, light cyan, light red or light magenta, light yellow, light cyan or light black. The light color inks have a lower content of pigment compared to the respective non-light color ink, preferably less than two third or less than a half or less than the pigment contained in the respective non-light color ink. For example, light red ink comprises a lower amount of pigment compared to the red ink. It is noted that using spot colors like red, light cyan or light magenta it is possible to increase the gamut or tailor the obtainable gamut on the specific décor to be printed while reducing the amount of ink to be printed. For example, for printing wood décor it may be preferable to substitute magenta ink with red ink. The inventors have found that by reducing the amount of ink to be printed, it is possible to reduce the amount of ink receiver coating as well and that an ink receiver coating in a lower amount has a lower risk of forming porosity thereby improving the subsequent lacquering.

Said printed paper can comprise a lacquer on top of the printed décor. The lacquer can be preferably directly on top of the decorative pattern, for example without the presence of any other layer between the decorative pattern and the lacquer. The lacquer preferably forms the uppermost layer of the decorative paper. Advantageously the lacquer is transparent or translucent.

Said lacquer can comprise or consist of acrylic resin, water-based acrylic, water-based polyurethane, hydro-UV resin or acid curable lacquers or mixture thereof. The lacquer can be a curable for example via heat, UV, EB, or acid and/or by use of a crosslinking agent such as isocyanates and the like.

The lacquer can be formed by a single or more superimposed layers for example a basecoat and a topcoat, each of said superimposed layers of the lacquer can have the same composition or a different composition none or some components in common.

The lacquer can be present on the decorative paper can be present in an amount between 4 and 60 g/m2, preferably between 5 and 30 g/m2. For example, each of the superimposed layers forming the lacquer can be present on the decorative paper in an amount between 4 and 20 g/m2. The inventors have found that said amount are sufficient to provide a good protection of the decorative pattern without causing curling of the paper so that the decorative paper can be used to clad support having various shapes.

The obtained decorative paper is attached on top of a support by means of a glue. Said substrate can be made of wood based material, cement based material, mineral based material, plastic or metal.

According to the most important example of the invention, a printable paper comprises a base paper having a weight between 50 and 120 g/m2 said base paper being impregnated with polymeric binder, said polymeric binder being acrylic or polyurethane based and being formaldehyde free. The printable paper comprising an ink receiver coating in the form of a single layer. The ink receiver coating comprises: a binder, said binder being polyvinyl alcohol; a flocculant in form of a cationic metal salt, preferably CaCl2, MgCl2 or Al Cl2. Said ink receiver coating is present on the surface of the paper in an amount between 0.2 and 5 g/m² dry coating weight, wherein said flocculant forms between 20 and 80% weight of the ink receiver coating. The ink receiver coating is free from water absorbing substance.

According to a special variant of said most preferred embodiment, the ink receiver coating comprises water absorbing particles in the form of silica particles having an average diameter below 5 μm. Said ink receiver coating comprises a particle to binder ratio between 1/20 and 10/1.

A second independent aspect of the invention relates to a method for manufacturing a printable paper layer, for example as according to the first independent aspect. Said polymeric binder is preferably applied to the base paper layer during the manufacturing of the paper itself, for example in-line with the papermill. The method can comprise the step of providing a base paper sheet being impregnated with a polymeric binder. Preferably, the method further comprises the step of proving the ink receiver coating on said base paper sheet. The ink receiver coating is preferably applied on top of the base paper sheet in a coating station that is preferably separate from the papermill.

It is clear that the invention also concerns decorative paper that comprises a decorative pattern on top of a printable paper according to the first independent aspect. Thereto according to its second independent aspect, the present invention relates to a printable paper for being printed by inkjet printing, comprising a base paper sheet being at least partially impregnated with a polymeric binder and an ink receiver coating provided on at least a surface of said base paper sheet, said ink receiver coating comprising at least a binder and a flocculant salt, and a decorative pattern formed on and/or in said ink receiver coating. Preferably said decorative paper comprises at least one lacquer layer above the decorative pattern. Said decorative paper of the second independent aspect can comprise one or more of the features described in relation to the independent aspect. In particular, the base paper, the ink receiver coating, the ink, the decorative pattern and the lacquer can each show one or more of features described in relation to the first independent aspect.

The invention, according to its third independent aspect, relates to a method for manufacturing a decorative paper, preferably according to the second independent aspect. According to said third independent aspect, the method comprises the steps of:
providing a printable paper, said printable paper comprising a base paper and a polymeric binder impregnating said base paper, and an ink receiver coating on an upper surface of said base paper, preferably said printable paper being according to the first independent aspect;
printing a decorative pattern on said printable paper, preferably said printing operation being an inkjet printing process;
optionally providing at least one lacquer layer on top of said decorative pattern, preferably said lacquer being a curable lacquer and said method comprising the step of curing said lacquer layer.

It is noted that the method of the third independent aspect can comprise one or more of the features described in relation to the first and second independent aspect. In particular, the base paper, the ink receiver coating, the ink, the decorative pattern and the lacquer can each show one or more of features described in relation to the first and/or second independent aspect.

In a first preferred embodiment of this third independent aspect, the step of providing the print can comprise the step of providing a printable paper having already the ink receiver coating, for example by unrolling said printable paper from a roll.

In a second preferred embodiment the step of providing the print can comprise the step of providing a base paper layer being impregnated with the polymeric binder and the sub step of providing the ink receiver coating on top of said base paper layer, preferably in line with said printer. Preferably, ink receiver layer is provided in liquid form, more preferably in a water-based solution. Preferably, said ink receiver coating is at least partially dried before printing said decorative pattern.

It is noted that said invention also concerns a decorative element, for example a furniture element, a skirting board, a wall panel, a ceiling panel, a door or a profile element, comprising a substrate and a top layer wherein said top layer comprises the decorative paper of the second aspect, preferably said top layer further comprising a glue adapted to attach said decorative paper on said substrate. Said substrate can be made of a wood-based material, like MDF, HDF, OSB, chipboard, or of any other material like for example mineral based, plastic or metal material. The substrate can be in form of a panel or of any other shape. In particular, the surface of the substrate covered by the decorative paper can be curved or, in any case, not flat.

### BRIEF DESCRIPTION OF THE DRAWINGS

With the intention of better showing the characteristics according to the invention, in the following, as an example without limitative character, an embodiment is described, with reference to the accompanying drawings, wherein:

FIG. 1 shows a cross section of a printable paper according to the invention;

FIGS. 2a and 2b on a larger scale show a view on the area F2 indicated on FIG. 1 respectively according to a first and a second preferred embodiment;

FIG. 3 shows a top view of a decorative paper obtainable starting from the printable paper of FIG. 1;

FIG. 4 on a larger scale shows a cross section along plane IV-IV of FIG. 3;

FIG. 5 illustrates some steps of a method for manufacturing the decorative paper of FIG. 3 in accordance with a first embodiment of an independent aspect of the invention;

FIG. 6 illustrates some steps of a method for manufacturing the decorative paper of FIG. 3 in accordance with a second embodiment of an independent aspect of the invention; and

FIG. 7 shows a decorative element comprising the decorative paper of FIG. 4.

### DESCRIPTION OF NON-LIMITING EMBODIMENTS

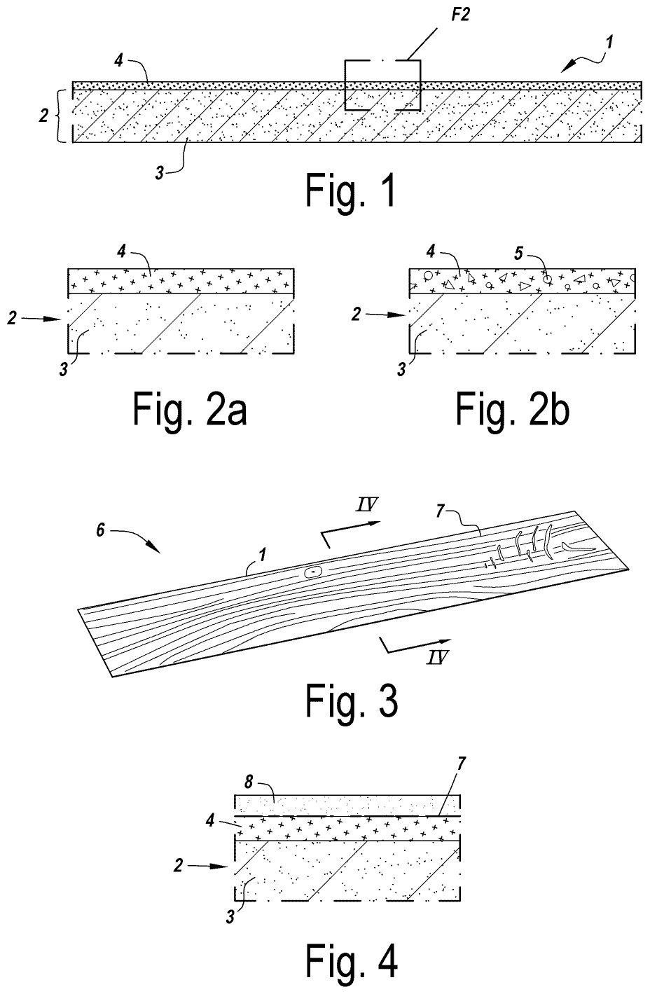

FIG. 1 illustrates a printable paper 1 for incorporation in a decorative element. The printable paper 1 comprises a base paper layer 2 provided with a polymeric binder 3. The resin 3 satisfies or fills the base paper layer 2.

The base paper layer comprises a weight between 50 and 120 g/m2 without the polymeric binder 3.

The polymeric binder preferably comprises a polymer latex like a (meth)acrylic dispersion, a polyurethane dispersion, preferably water-based polyurethane dispersion, starch dispersion or a combination thereof. The printable paper is free from formaldehyde, for example the formaldehyde content is below 0.2 mg/m2h according to gas analysis method DIN EN ISO 12460-3.

The printable paper 1 has been provided with an ink receiver coating 4 on one of its surfaces. Said ink receiver coating 4 being present in the base paper layer in an amount between 0.2 and 5 g/m². The ink receiver coating 4 is in the form of a single layer

The ink receiver coating 4 comprises a binder and a flocculant and, in the first preferred embodiment of FIG. 2a, is free from any water absorbing substance.

The binder in the ink receiver coating can be selected from the group comprising polyvinyl-alcohol, polyvinyl acetates, ethylvinylacetates, block copolymers based on polyvinylacetate, block copolymers based on polyvinylalcohol, acrylates, latexes, polyvinyl derivates, polyurethanes based on polyols and isocyanates, polyurethanes based on polycarbamates and polyaldehydes, e.g. both as a watery dispersion/emulsion or a watery or solvent solution.

The flocculant is in form of a cationic metal salt, for example preferably a cationic metal salt. Preferably said metal salt is chosen from the list consisting of CaCl2, MgCl2, CaBr2, MgBr2, CMA (Calcium Magnesium Acetate), NH4Cl, Calcium Acetate, ZrCl4, calcium nitrate and Magnesium Acetate. The flocculant being present in the inkjet receiver coating in an amount between 20 and 80% by weight.

FIG. 2b shows a second preferred embodiment of the invention that differs from the first preferred embodiment of FIG. 2a only in that the inkjet receiver coating 4 comprises a water absorbing substance 5, preferably silica particles. Alternatively, or in combination, said water absorbing substance 5 can be in form of kaolin or other aluminosilicate material.

Said water absorbing substance 5 is preferably in form of particle having a maximum particle size of 7 microns, more preferably of 5 microns. Said ink receiver coating 4 comprises a particle to binder ratio between 1/20 and 10/1.

FIGS. 3 and 4 show a decorative paper 6 obtained starting from the printable paper 1 of FIG. 1. The decorative paper 6 comprises a decorative pattern 7 in the form of a digitally printed ink layer that, preferably, covers the majority of the paper upper surface. Such decorative pattern 7 might for example represent a wood pattern, a stone pattern or a fantasy pattern. The decorative pattern 7 is present on and/or in the ink receiver coating 4. The decorative pattern 7 is obtained using pigment containing inks and preferably is formed by a dry pigment content below 9 g/m2.

As visible from FIG. 4 the decorative paper further comprises a lacquer 8 on top of the decorative pattern 7. In the example the lacquer 8 is made of an acrylic resin, for example UV cured. The lacquer is transparent or at least translucent so that the decorative pattern is visible through the lacquer 8 itself.

The lacquer 8 is present in the decorative paper 6 in an amount between 4 and 60 g/m2, preferably between 5 and 30 g/m2.

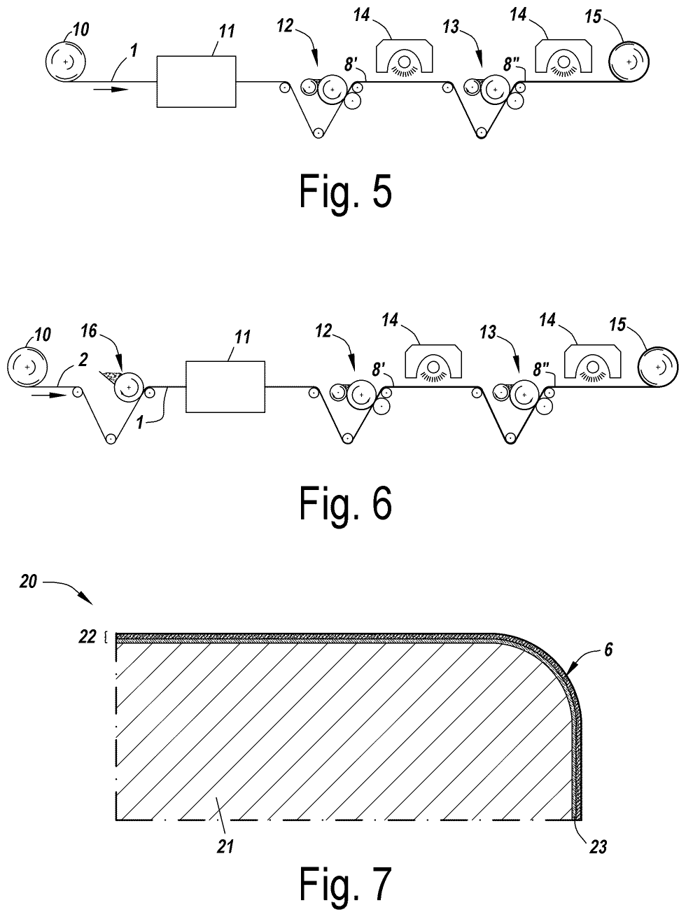

FIG. 5 shows some steps in a method for manufacturing the decorative paper 6 according to a first preferred embodiment of the method.

In this first preferred embodiment of the method for manufacturing the decorative paper 6, the printable paper 1 is fed from a roll 10 to an inkjet printer 11.

Said inkjet printer 11 is a single pass printer adapted to print with multiple colored inks, for example cyan, yellow, black and red or magenta. In the example the inks are water-based pigmented inks.

The inkjet printer 11 prints the decorative pattern 7 on the printable paper 1 by jetting droplets of the inks on the inkjet receiver coating. The printed paper can be dried during and/or immediately after printing to remove water from the decorative pattern 7 and obtain an immediate drying of the ink.

In the embodiment shown in FIG. 5 the method comprises a step of providing the lacquer 8 on top of the decorative pattern 7. In the example a first lacquer layer 8′ is provided in liquid and uncured form by means of a first coating device 12 on the decorative pattern 7. The first lacquer layer 8′ is provided in an amount variable between 5 and 20 g/m2. In the example a second lacquer layer 8″ is provided in liquid and uncured form by means of a second coating device 13 on the first lacquer layer 8′. The second lacquer layer 8″ is provided in an amount variable between 5 and 20 g/m2.

In the example, said first and or second coating device 12 and 13 are roller coater devices.

In the example, between the application of the first and of the second lacquer layer 8′, 8″ a partial curing of the first lacquer layer 8′ is performed using one or more UV lamps 14. After application of the second lacquer layer 8″ complete curing of the first and second lacquer layer 8″ is performed using one or more UV lamps 14. After complete curing the first and second lacquer layer 8′ and 8″ are indistinct from each other and form the lacquer 8. It is noted that in alternative embodiments the first and second lacquer layer 8′ and 8″ may be distinct from each other after complete curing.

The obtained decorative paper 6 is then rolled up on a second roller 15.

The second preferred embodiment of the method for manufacturing the decorative paper 6 illustrated in FIG. 6 differs from the method of FIG. 5 only in that from the first roll 10 is unrolled the base paper 2 having the polymeric binder but being free from the ink receiver coating 4. The method of FIG. 6 further comprises the step of applying the ink receiver coating 4 on the upper surface of the base paper 2 by means of a coating device 16 like, for example, a reverse roller. As illustrated in FIG. 6, the ink receiver coating is applied in line with the inkjet printer 11.

FIG. 7 shows a cross section of a decorative element 20 like a furniture panel comprising a substrate 21 and a top layer 22 wherein the top layer comprises the decorative paper 6.

The substrate 21, in the example, is made of a wood-base material like MDF, HDF, chipboard or OSB, anyway in alternative examples can be made of any other material like plastic or metal.

The top layer 22 comprises a glue layer 23 disposed below the decorative paper 6 and adapted to attach the decorative paper 6 to the substrate 21.

The present invention is in no way limited to the above described embodiments, but such methods, equipment and treated paper layers may be realized according to several variants without leaving the scope of the invention.

The invention is further disclosed by the following item list as defined by the below numbered items.
1.—A printable paper (1) for being printed by inkjet printing and forming a decorative paper (6), comprising a base paper layer (2) being at least partially impregnated with a polymeric binder, preferably said polymeric binder being substantially free from formaldehyde, and an ink receiver coating (4) provided on at least a surface of said base paper layer (2), said ink receiver coating (4) comprising at least a binder and a flocculant, preferably a cationic metal salt.
2.—The printable paper (1) according to item 1, wherein said flocculant comprises a cationic metal salt preferably chosen from the list consisting of CaCl₂, MgCl₂, CaBr₂, MgBr₂, CMA (Calcium Magnesium Acetate), NH₄Cl, Calcium Acetate, ZrCl₄, calcium nitrate and Magnesium Acetate or a mixture thereof.
3.—The printable paper (1) according to item 1 or 2, wherein said cationic metal salt is provided in an amount of at least 20% weight on the total dry weight of the ink receiver coating, preferably in an amount between 20 and 80% weight.
4.—The printable paper (1) according to any of the preceding items, wherein said ink receiver coating (4) is in the form of a single layer.
5.—The printable paper (1) according to any of the preceding items, wherein said ink receiver coating (4) is substantially free from water absorbing particles.
6.—The printable paper (1) according to any of items from 1 to 4, wherein said ink receiver coating (4) comprises water absorbing particles (5), and wherein:
   the particle to binder ratio in said ink receiver coating (4) is above 1/20; and/or
   said water absorbing particles (6) comprise a maximum diameter below 7 μm.
7.—The printable paper (1) according to any of the preceding items, wherein said binder of the ink receiver coating (4) comprises polyvinyl alcohol, acrylic base resin, polyurethane-based resin or a combination thereof.
8.—The printable paper (1) according to any of the preceding items, wherein a dry amount of ink receiver coating (4) between 0.2 and 5 g/m².
9.—The printable paper (1) according to any of the preceding items, wherein the polymeric binder comprises an acrylic resin, a polymer latex like a (meth)acrylic dispersion, a polyurethane dispersion, preferably water-based polyurethane dispersion, starch dispersion or a combination thereof.
10.—A decorative paper (6) comprising the printable paper (1) of any of the preceding items and a decorative pattern (7), preferably further comprising a lacquer (8) above said decorative pattern (7).
11.—The decorative paper (6) of item 10, wherein said decorative pattern (7) is formed by a plurality of pigments, said pigments being selected from the group comprising, preferably consisting of: cyan, yellow, black, red or magenta.
12.—The decorative paper (6) of item 10 or 11, wherein it comprises an amount of said lacquer (8) between 4 and 60 g/m², preferably between 5 and 30 g/m².
13.—A method for manufacturing the printable paper (1) of any of the item from 1 to 9, comprising the steps of:
providing a base paper layer (2) being at least partially impregnated with a polymeric binder;
coating one surface of the base paper layer (2) with an ink receiver coating (4) composition comprising the binder and the flocculant.
14.—The method according to item 13, wherein said coating step is performed in line with a printer (11) for providing said printable paper (1) with a decorative pattern (7).
15.—A method for manufacturing a decorative paper (6) comprising the steps of:
   providing a printable paper (1) whether or not according any of the items from 1 to 9;
   inkjet printing a decorative pattern (7) on said printable paper (1);
   optionally providing at least one lacquer layer (8′, 8″) above said decorative pattern (7).
16.—The method according to item 15, wherein said step of printing pigment containing and/or water-based inks are used.
17.—The method according to item 15 or 16, wherein said step of printing is used a set of multiple inks wherein said set comprises cyan, yellow, black and red or magenta ink.
18.—The method according to item 15 or 16, wherein said step of providing the printable paper (1) comprises the sub steps of:
   providing a base paper layer (2) being at least partially impregnated with a polymeric binder;
   coating one surface of the base paper layer (2) with an ink receiver coating (4) composition comprising a binder and a flocculant, preferably said coating sub step being performed in line with the printer for printing the decorative pattern (7).
19.—A decorative element (20), for example wall, ceiling, furniture elements, profiled elements like skirtings, or edge banding, comprising a substrate (21) and a top layer (22), wherein said top layer (22) comprises a decorative paper (6) according to any of items from 10 to 12, preferably said top layer further comprises a glue (23) for attaching said decorative paper (6) to said substrate (1).
20.—The decorative element (20) according to item 19, wherein the substrate is made of wood-based material, mineral based material, plastic or metal.
21.—The decorative element (20) according to item 19 or 20, wherein the substrate (21) comprises a surface covered by the top layer (22), said surface being non flat.

1. A printable paper for being printed by inkjet printing and forming a decorative paper, the printable paper comprising:
a base paper layer being at least partially impregnated with a polymeric binder; and
an ink receiver coating provided on at least a surface of the base paper layer;
wherein the ink receiver coating includes at least a binder and a flocculant.

2. The printable paper according to claim 1, wherein the flocculant comprises a cationic metal salt preferably-chosen from the list consisting of CaCl₂, MgCl₂, CaBr₂, MgBr₂, CMA (Calcium Magnesium Acetate), NH₄Cl, Calcium Acetate, ZrCl₄, calcium nitrate, and Magnesium Acetate, or a mixture thereof.

3. The printable paper according to claim 2, wherein the cationic metal salt is provided in an amount of at least 20% weight on the total dry weight of the ink receiver coating.

4. The printable paper according to claim 1, wherein the ink receiver coating is in the form of a single layer.

5. The printable paper according to claim 1, wherein the ink receiver coating is substantially free from water absorbing particles.

6. The printable paper according to claim 1, wherein the ink receiver coating comprises water absorbing particles, and wherein:
a particle to binder ratio in the ink receiver coating is above 1/20; and/or
the water absorbing particles have a maximum diameter below 7 μm.

7. The printable paper according to claim 1, wherein the binder of the ink receiver coating comprises polyvinyl alcohol, acrylic base resin, polyurethane-based resin, or a combination thereof.

8. The printable paper (1) according to claim 1, wherein a dry amount of the ink receiver coating is between 0.2 and 5 g/m².

9. The printable paper according to claim 1, wherein the polymeric binder comprises an acrylic resin, a polymer latex, a polyurethane dispersion, a starch dispersion, or a combination thereof.

10. A decorative paper comprising:
the printable paper of claim 1; and
a decorative pattern provided on the ink receiver coating; and
a lacquer provided above the decorative pattern.

11. The decorative paper of claim 10, wherein the decorative pattern is formed by a plurality of pigments that are selected from the group comprising cyan, yellow, black, red, or magenta.

12. The decorative paper of claim, wherein the lacquer is present in an amount between 4 and 60 g/m².

13. A method for manufacturing the printable paper of claim 1, the method comprising:
providing the base paper layer being at least partially impregnated with a polymeric binder; and
coating a surface of the base paper layer with an ink receiver coating composition comprising the binder and the flocculant.

14. The method according to claim 13, wherein the coating is performed in line with a printer for providing the printable paper with a decorative pattern.

15. A method for manufacturing a decorative paper, the method comprising:
providing a printable paper according to claim 1;
inkjet printing a decorative pattern on the printable paper; and
providing a lacquer layer above the decorative pattern.

16. (canceled)

17. The method according to claim 15, wherein the inkjet printing uses a set of multiple inks that comprises cyan, yellow, black, and red or magenta ink.

18. The method according to claim 15, wherein providing the printable paper comprises:
providing the base paper layer being at least partially impregnated with the polymeric binder; and
coating a surface of the base paper layer with the ink receiver coating composition comprising the binder and the flocculant.

19. A decorative element comprising:
a substrate; and
a top layer, provided on the substrate;
wherein the top layer includes a decorative paper according to claim 10.

20. The decorative element according to claim 19, wherein the substrate is made of wood-based material, mineral based material, plastic, or metal.

21. The decorative element according to claim 19, wherein the substrate comprises a surface covered by the top layer, the surface being non flat.
